(19) United States
(12) Patent Application Publication
(10) Pub. No.: US 2019/0186969 A1
(43) Pub. Date: Jun. 20, 2019

(54) SENSING DEVICE AND METHOD FOR MANUFACTURING THE SAME

(71) Applicant: INDUSTRIAL TECHNOLOGY RESEARCH INSTITUTE, Hsinchu (TW)

(72) Inventors: Shih-Yao Chen, Kaohsiung City (TW); Kuan-Wei Chen, Taichung City (TW); Pei-Jer Tzeng, Zhubei City (TW); Wen Wang, New Taipei City (TW)

(73) Assignee: INDUSTRIAL TECHNOLOGY RESEARCH INSTITUTE, Hsinchu (TW)

(21) Appl. No.: 15/883,619

(22) Filed: Jan. 30, 2018

(30) Foreign Application Priority Data
Dec. 19, 2017 (TW) 106144565

(51) Int. Cl. G01F 1/684

(52) U.S. Cl. CPC G01F 1/6847

(57) ABSTRACT

The disclosure provides a sensing device including a supporting member, a thermal resistance portion, a sensing unit and a heating unit. The supporting member has a supporting surface. The thermal resistance portion is located within the supporting member, wherein a thermal conductivity of the thermal resistance portion is less than a thermal conductivity of the supporting member. The sensing unit is disposed on the supporting surface. The heating unit is disposed on the supporting surface, wherein the heating unit is configured to heat the sensing unit, and an orthogonal projection of the heating unit on the supporting surface overlaps an orthogonal projection of the thermal resistance portion on the supporting surface. In addition, the disclosure also provides a method for manufacturing the sensing device.

### CROSS-REFERENCE TO RELATED APPLICATIONS

This non-provisional application claims priority under 35 U.S.C. § 119(a) on Patent Application No(s). 106144565 filed in Taiwan, R.O.C. on Dec. 19, 2017, the entire contents of which are hereby incorporated by reference.

### TECHNICAL FIELD

The disclosure relates to a sensing device and method for manufacturing the same, more particularly to a sensing device, capable of improving sensing effect by rising temperature, and a method for manufacturing the same.

### BACKGROUND

When a sensor is in operation, its sensing component needs properly heated in order to increase the sensitivity and reduce the reaction time. Therefore, some sensors are additionally equipped with a heater around the sensing component to raise the temperature of the sensing component.

### SUMMARY

One embodiment of the disclosure provides a sensing device including a supporting member, a thermal resistance portion, a sensing unit and a heating unit. The supporting member has a supporting surface. The thermal resistance portion is located within the supporting member, wherein a thermal conductivity of the thermal resistance portion is less than a thermal conductivity of the supporting member. The sensing unit is disposed on the supporting surface. The heating unit is disposed on the supporting surface, wherein the heating unit is configured to heat the sensing unit, and an orthogonal projection of the heating unit on the supporting surface overlaps an orthogonal projection of the thermal resistance portion on the supporting surface.

One embodiment of the disclosure provides a method for manufacturing a sensing device, the method includes: forming a thermal resistance portion within a supporting member, wherein a thermal conductivity of the thermal resistance portion is less than a thermal conductivity of the supporting member; disposing a sensing unit on a supporting surface of the supporting member; and disposing a heating unit on the supporting surface of the supporting member, wherein the heating unit is configured to heat the sensing unit, and an orthogonal projection of the heating unit on the supporting surface overlaps an orthogonal projection of the thermal resistance portion on the supporting surface.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is a cross-sectional side view of a sensing device according to one embodiment of the disclosure;

FIGS. 2-5 show a method for manufacturing the sensing device in FIG. 1;

FIG. 6 is a cross-sectional side view of a sensing device according to another embodiment of the disclosure;

FIG. 7 is a cross-sectional side view of a sensing device according to yet another embodiment of the disclosure;

FIG. 8 is a cross-sectional side view of a sensing device according to still another embodiment of the disclosure;

FIG. 9 is a cross-sectional side view of a sensing device according to yet still another embodiment of the disclosure; and

FIG. 10 is a cross-sectional side view of a sensing device according to further another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known main structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure. Furthermore, in order to simplify the drawings, some conventional structures and components are drawn in a simplified manner to keep the drawings clean.

Moreover, the size, ratio and angle of the components in the drawings of the present disclosure may be exaggerated for illustrative purposes, but the present disclosure is not limited thereto, and various modifications can be made without departing from the spirit of the present disclosure.

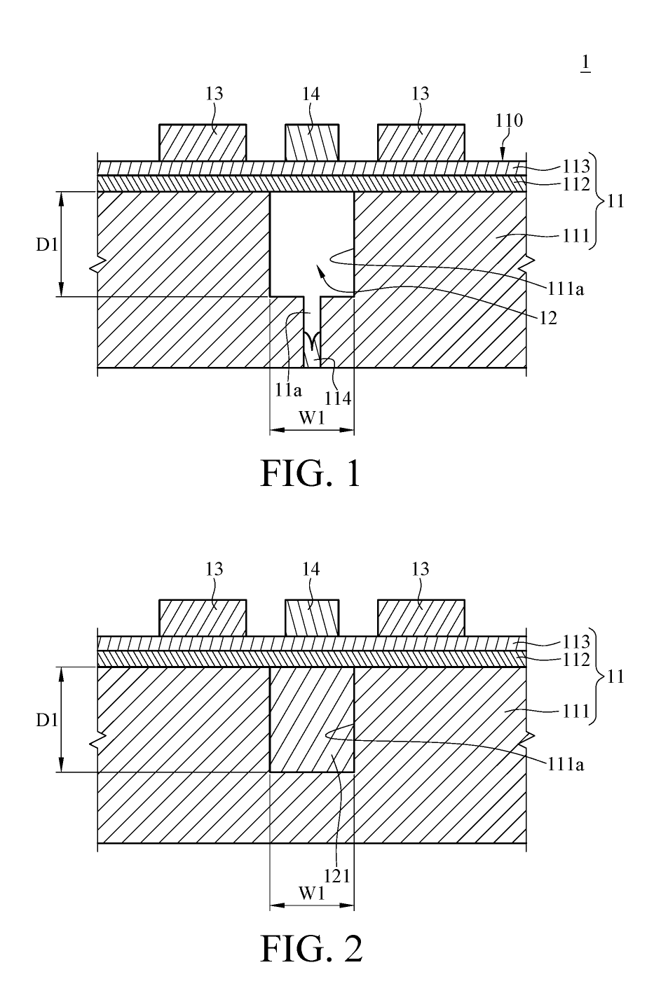

Please refer to FIG. 1 which is a cross-sectional side view of a sensing device according to one embodiment of the disclosure. This embodiment provides a sensing device 1 that includes a supporting member 11, a thermal resistance portion 12, a plurality of sensing units 13 and a heating unit 14.

The supporting member 11 includes a substrate 111, an isolation layer 112, a passivation layer 113 and a sealer 114. The substrate 111 has a recess 111a. The isolation layer 112 is stacked on the substrate 111. The passivation layer 113 is stacked on the isolation layer 112. The supporting member 11 has a supporting surface 110 on the side of the passivation layer 113 facing away from the isolation layer 112. The substrate 111 and the isolation layer 112 surround the thermal resistance portion 12 at the recess 111a, such that the thermal resistance portion 12 is located within the supporting member 11. The supporting member 11 has a through hole 11a connected to the thermal resistance portion 12. The sealer 114 is disposed in the through hole 11a. The thermal resistance portion 12 has a thermal conductivity less than a mean thermal conductivity or the minimum thermal conductivity of the supporting member 11. The mean thermal conductivity of the supporting member is determined by the weighted mean of the thermal conductivities of the materials contained in the supporting member. The minimum thermal conductivity of the supporting member means is the thermal conductivity of the material with the lowest thermal conductivity of all materials contained in the supporting member. The isolation layer 112 is taken as an interface for the substrate 111, and it is made of, for example, silicon dioxide, nitric oxide, glass material, or ceramic material. In comparing the supporting member 11 and the other components, the passivation layer 113 is made of semiconductor material having a relatively low thermal conductivity, a relatively low coefficient of thermal expansion and a relatively high elastic modulus or made of ceramic material having a high degree of hardness.

In this embodiment, the recess 111a has a depth D1 and a width W1 in a ratio of 2:1, but the present disclosure is not limited thereto. In addition, in this embodiment, due to the sealer 114 being disposed in the through hole 11a, the thermal resistance portion 12 becomes a sealed chamber, and the thermal conductivity of the thermal resistance portion 12 is approximately the same as that of a vacuum environment or an almost vacuum environment, but the present is not limited thereto. In some other embodiments, the supporting member may have no sealer 114; in such a case, the thermal resistance portion 12 would become an open chamber, and the thermal conductivity of the thermal resistance portion 12 would be the same as that of the environment. Furthermore, in this embodiment, the through hole 11a penetrates through the substrate 111 and connects to the thermal resistance portion 12, but the present disclosure is not limited thereto. In some other embodiments, the through hole 11a may further penetrate through the isolation layer 112 and the passivation layer 113.

The sensing units 13 and the heating unit 14 are disposed on the supporting surface 110. The heating unit 14 is able to heat the sensing units 13. An orthogonal projection of the thermal resistance portion 12 on the supporting surface 110 overlaps an orthogonal projection of the heating unit 14 on the supporting surface 110. However, the locations of the sensing units 13 and the heating unit 14 are not restricted. In some other embodiments, the sensing units 13 may be stacked on the heating unit 14, such that the heating unit 14 may be located between the sensing units 13 and the supporting surface 110.

The orthogonal projection of the thermal resistance portion 12 on the supporting surface 110 overlapping the orthogonal projection of the heating unit 14 on the supporting surface 110 is beneficial to slow down the heat transfer between the heating unit 14 and the supporting member 11. Therefore, heat generated by the heating unit 14 has higher likelihood to be transferred to the sensing units 13 in order to maintain the temperature of the sensing units 13. As a result, the desired function of the sensing units 13 can be maintained with a less power consumption of the heating unit 14.

Please refer to FIG. 1 and further refer to FIGS. 2-5. FIGS. 2-5 show a method for manufacturing the sensing device in FIG. 1. The method of manufacturing the sensing device 1 includes the following steps.

As shown in FIG. 2, the recess 111a of the substrate 111 of the supporting member 11 is formed by, for example, etching. The ratio of the depth D1 to the width W1 may be less than 2:1. The recess 111a is filled with a volatile substance 121. The isolation layer 112 is stacked on the substrate 111 and the volatile substance 121. When stacking the isolation layer 112 on the substrate 111 and the volatile substance 121, the volatile substance 121 is in solid form. Then, the passivation layer 113 is stacked on the isolation layer 112. The supporting surface 110 of the supporting member 11 is on the side of the passivation layer 113 facing away from the isolation layer 112. The sensing units 13 and the heating unit 14 are disposed on the supporting surface 110 of the supporting member 11, allowing the heating unit 14 to heat the sensing units 13, and the orthogonal projection of the heating unit 14 on the supporting surface 110 to overlap the orthogonal projection of the recess 111a on the supporting surface 110.

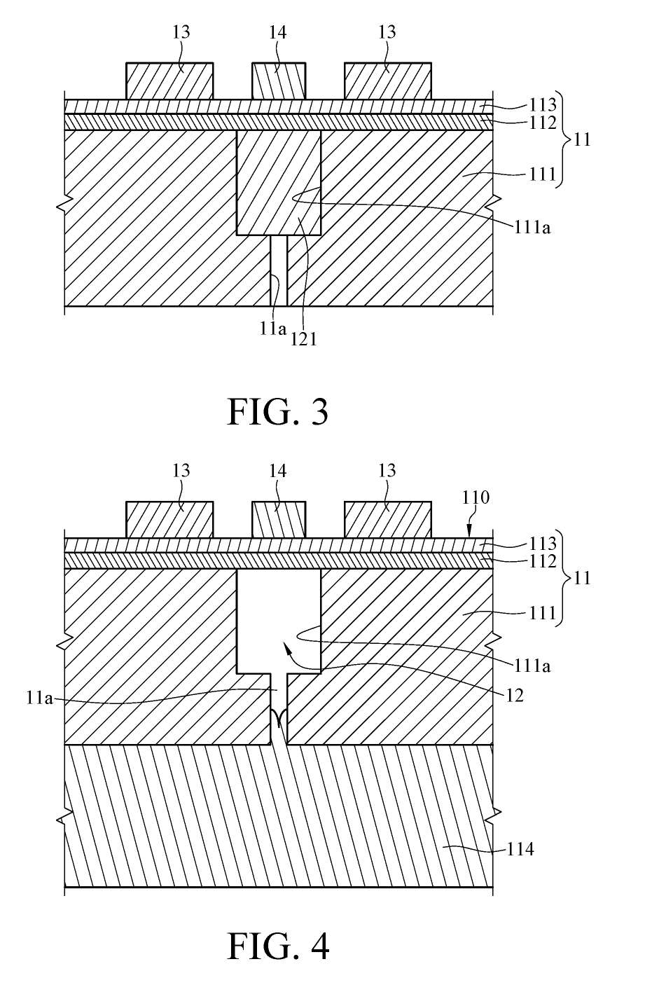

Then, as shown in FIG. 3, the through hole 11a which penetrates through the substrate 111 and connects to the recess 111a is formed in the supporting member 11, but the present disclosure is not limited thereto. In some other embodiments, the through hole may further penetrate through the isolation layer 112 and the passivation layer 113. Then, by heating, the volatile substance 121 is volatilized away from the substrate 111 through the through hole 11a, such that the thermal resistance portion 12, which is located within the supporting member 11 and surrounded by the substrate 111 and the isolation layer 112, is formed at the recess 111a. At this moment, the thermal resistance portion 12 is an open chamber, and the thermal conductivity of the thermal resistance portion 12 is the same as that of air in the environment and less than the mean thermal conductivity or the minimum thermal conductivity of the supporting member 11.

Then, as shown in FIG. 4, the sealer 114 is formed to seal the through hole 11a in a vacuum environment or an almost vacuum environment. The material of the sealer 114 is gradually accumulated on an inner surface of the through hole 11a at one end and then seals the through hole 11a. As this moment, the thermal resistance portion 12 becomes a sealed chamber, and the thermal conductivity of the thermal resistance portion 12 would be approximately the same as that of a vacuum environment or an almost vacuum environment and less than the mean thermal conductivity or the minimum thermal conductivity of the supporting member 11. In addition, a part of the sealer 114 is located in the through hole 11a, and the other part of the sealer 114 is located outside the through hole 11a. The thickness of the part of the sealer 114 located outside the through hole 11a is approximately two times the thickness of the part of the sealer 114 located in the through hole 11a, but the present disclosure is not limited thereto.

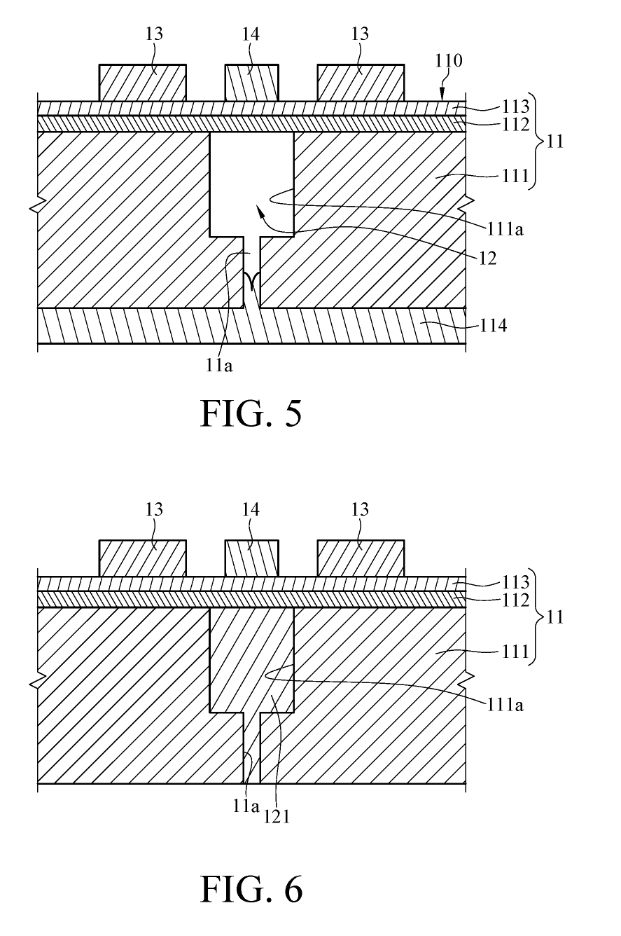

Then, as shown in FIG. 5, the part of the sealer 114 located outside the through hole 11a is flattened; for example, as shown in FIG. 1, the part of the sealer 114 located outside the through hole 11a is removed, remaining the part of the sealer 114 located in the through hole 11a.

Please refer to FIGS. 1 and 6. FIG. 6 is a cross-sectional side view of a sensing device according to another embodiment of the disclosure. The method of manufacturing the sensing device 1 in FIGS. 1 and 6 is similar to that in FIGS. 1 to 5, so it will not be repeated again. In this embodiment, the method of manufacturing the sensing device 1 includes the following steps.

As shown in FIG. 6, the recess 111a is formed in the substrate 111 of the supporting member 11. The through hole 11a connected to the recess 111a is formed in the substrate 111 of the supporting member 11. The volatile substance 121 is filled in the recess 111a; alternately, the volatile substance 121 is filled in the recess 111a and a part of the through hole 11a; or the volatile substance 121 is filled in the recess 111a and the whole through hole 11a. The isolation layer 112 is stacked on the substrate 111 and the volatile substance 121. The passivation layer 113 is stacked on the isolation layer 112. The supporting surface 110 of the supporting member 11 is formed on the side of the passivation layer 113 facing away from the isolation layer 112. The sensing units 13 and the heating unit 14 for heating the sensing units 13 are disposed on the supporting surface 110 of the supporting member 11. The orthogonal projection of the heating unit 14 on the supporting surface 110 overlaps the orthogonal projection of the recess 111a on the supporting surface 110.

Then, by heating, the volatile substance 121 is volatilized away from the substrate 111 through the through hole 11a, such that the thermal resistance portion 12, which is located within the supporting member 11 and surrounded by the substrate 111 and the isolation layer 112, is formed at the recess 111a. At this moment, the thermal resistance portion 12 is an open chamber, and the thermal conductivity of the thermal resistance portion 12 is the same as that of air in the environment and less than the mean thermal conductivity or the minimum thermal conductivity of the supporting member 11.

Then, as shown in FIG. 4, the sealer 114 is formed to seal the through hole 11a in a vacuum environment or an almost vacuum environment. As this moment, the thermal resistance portion 12 becomes a sealed chamber, and the thermal conductivity of the thermal resistance portion 12 would be approximately the same as that of the vacuum environment or the almost vacuum environment and less than the mean thermal conductivity or the minimum thermal conductivity of the supporting member 11. Then, as shown in, the part of the sealer 114 located outside the through hole 11a is flattened; for example, as shown in FIG. 1, the part of the sealer 114 located outside the through hole 11a is removed, remaining the part of the sealer 114 in the through hole 11a.

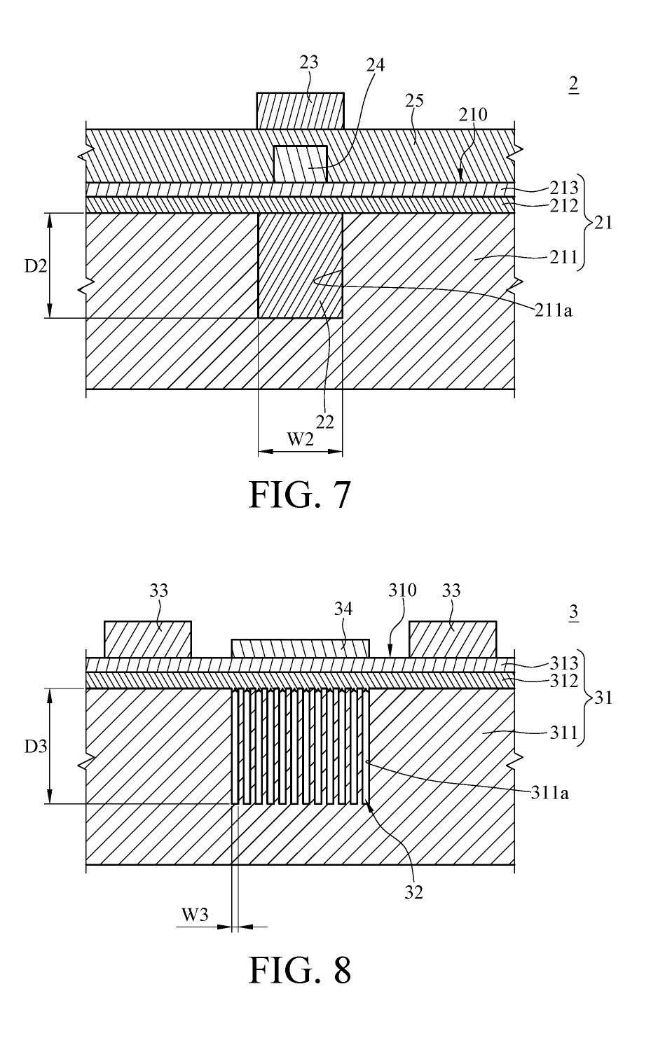

Please refer to FIG. 7 which is a cross-sectional side view of a sensing device according to yet another embodiment of the disclosure. This embodiment provides a sensing device 2 which includes a supporting member 21, a thermal resistance portion 22, a sensing unit 23, a heating unit 24 and a planarization layer 25.

The supporting member 21 includes a substrate 211, an isolation layer 212 and a passivation layer 213. The substrate 211 has a recess 211a. The thermal resistance portion 22 is filled in the recess 211a. The isolation layer 212 is stacked on the substrate 211 and the thermal resistance portion 22. The passivation layer 213 is stacked on the isolation layer 212. The supporting member 21 has a supporting surface 210 on a side of the passivation layer 213 facing away from the isolation layer 212. The substrate 211 and the isolation layer 212 surround the thermal resistance portion 22 at the recess 211a, such that the thermal resistance portion 22 is located within the supporting member 21. The thermal resistance portion 22 may be made of a solid or liquid material which contracts (or expands) slowly; in this embodiment, the thermal conductivity of the thermal resistance portion 22 is less than a mean thermal conductivity or the minimum thermal conductivity of the supporting member 21. For example, the thermal conductivity of the thermal resistance portion may be equal to or less than 150 W/(m·K). In this embodiment, the recess 211a has a depth D2 and a width W2 in a ratio equal to or less than 2:1, but the present disclosure is not limited thereto.

In addition, the heating unit 24 is disposed on the supporting surface 210 and located above the thermal resistance portion 22, such that an orthogonal projection of the thermal resistance portion 22 on the supporting surface 210 overlaps an orthogonal projection of the heating unit 24 on the supporting surface 210. The planarization layer 25 is stacked on the heating unit 24 and the supporting surface 210. The sensing unit 23 is disposed on the planarization layer 25 and located above the heating unit 24, such that the heating unit 24 is able to heat the sensing unit 23.

In this embodiment, the sensing unit 23 is stacked on the heating unit 24, such that the heating unit 24 is located between the sensing unit 23 and the supporting surface 210, but the present disclosure is not limited thereto. In some other embodiments, the sensing unit 23 may be stacked on the supporting surface 210 as the heating unit 24 does.

The method of manufacturing the sensing device 2 includes the following steps.

The recess 211a is formed in the substrate 211 of the supporting member 21. The recess 211a is filled with the thermal resistance portion 22. The isolation layer 212 is stacked on the substrate 211 and the thermal resistance portion 22. The passivation layer 213 is stacked on the isolation layer 212. The heating unit 24 is disposed on the supporting surface 210 of the passivation layer 213 of the supporting member 21. The orthogonal projection of the heating unit 24 on the supporting surface 210 overlaps the orthogonal projection of the thermal resistance portion 22 on the supporting surface 210. The planarization layer 25 is stacked on the heating unit 24 and the supporting surface 210. The sensing unit 23 is stacked on the planarization layer 25, such that the heating unit 24 is able to heat the sensing unit 23.

Please refer to FIG. 8 which is a cross-sectional side view of a sensing device according to still another embodiment of the disclosure. This embodiment provides a sensing device 3 which includes a supporting member 31, a thermal resistance portion 32, a plurality of sensing units 33 and a heating unit 34.

The supporting member 31 includes a substrate 311, an isolation layer 312 and a passivation layer 313. The substrate 311 has a plurality of recesses 311a. Each recess 311a has a depth D3 and a width W3 in a ratio equal to or greater than 10:1. The isolation layer 312 is stacked on the substrate 311. The passivation layer 313 is stacked on the isolation layer 312. The supporting member 31 has a supporting surface 310 on a side of the passivation layer 313 facing away from the isolation layer 312. The recesses 311a surrounded by the substrate 311 and the isolation layer 312 become a thermal resistance portion 32 located within the supporting member 31. In such a case, the thermal resistance portion 32 is consisted of a plurality of sealed chambers. The thermal conductivity of the thermal resistance portion 32 is approximately the same as that of a vacuum environment or an almost vacuum environment and is less than a mean thermal conductivity or the minimum thermal conductivity of the supporting member 31.

In addition, the sensing units 33 and the heating unit 34 are disposed on the supporting surface 310, such that an orthogonal projection of the heating unit 34 on the supporting surface 310 overlaps an orthogonal projection of the thermal resistance portion 32 on the supporting surface 310. The heating unit 34 is disposed at a position capable of heating the sensing units 33, but the distance therebetween is not particularly restricted.

The method of manufacturing the sensing device 3 includes the following steps.

A plurality of recesses 311a are formed in the substrate 311 of the supporting member 31. Each recess 311a has the depth D3 and the width W3 in a ratio equal to or greater than 10:1.

The isolation layer 312 is stacked on the substrate 311, such that the recesses 311a are surrounded and sealed by the substrate 311 and the isolation layer 312 to become the thermal resistance portion 32. The isolation layer 312 may be disposed on the substrate 311 by a process of Physical Vapor Deposition (PVD) or Chemical Vapor Deposition (CVD), but the process for forming the isolation layer 312 is not restricted. The deposition rate of the isolation layer 312 onto the substrate 311 is equal to or greater than, for example, 30 Å/sec. By doing so, the material of the isolation layer 312 would not enter the recesses 311a, such that the recess 311a are maintained sealed. In some cases, there are approximately less than 15% of the space in each recess 311a being occupied by the isolation layer 312.

The passivation layer 313 is stacked on the isolation layer 312. The sensing units 33 and the heating unit 34 are disposed on the supporting surface 310 of the passivation layer 313 of the supporting member 31. An orthogonal projection of the heating unit 34 on the supporting surface 310 overlaps an orthogonal projection of the thermal resistance portion 32 on the supporting surface 310. The heating unit 34 is disposed at a position capable of heating the sensing units 33, but the distance therebetween is not particularly restricted.

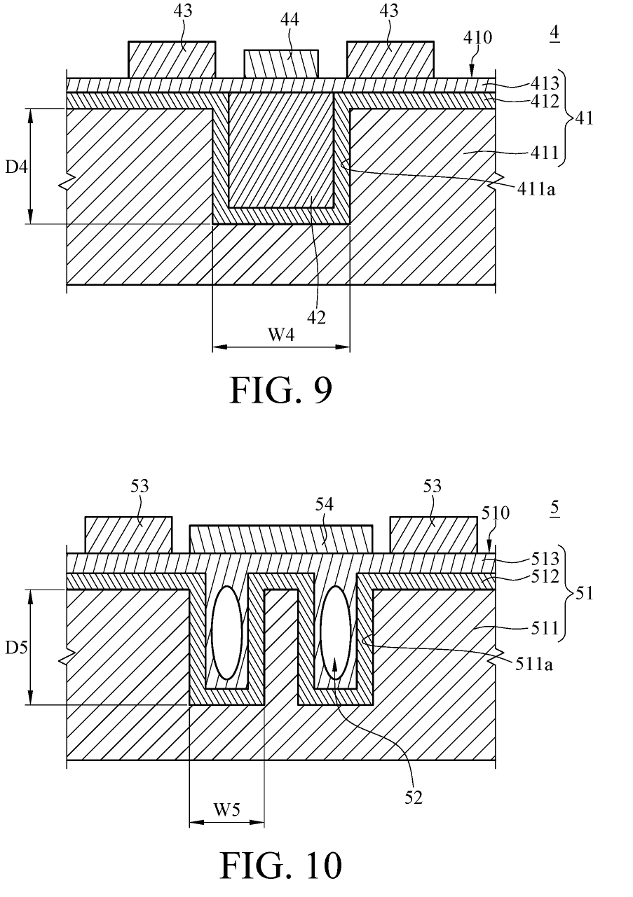

Please refer to FIG. 9 which is a cross-sectional side view of a sensing device according to yet still another embodiment of the disclosure. This embodiment provides a sensing device 4 which includes a supporting member 41, a thermal resistance portion 42, a plurality of sensing units 43 and a heating unit 44.

The supporting member 41 includes a substrate 411, an isolation layer 412 and a passivation layer 413. The substrate 411 has a recess 411a. The isolation layer 412 is stacked on the substrate 411 and in contact with an inner surface of the recess 411a. The thermal resistance portion 42 is filled into the recess 411a, and the thermal resistance portion 42 and the substrate 411 are separated by the isolation layer 412. The passivation layer 413 is stacked on the isolation layer 412 and the thermal resistance portion 42. The supporting member 41 has a supporting surface 410 on a side of the passivation layer 413 facing away from the isolation layer 412. The thermal resistance portion 42 in the recess 411a are surrounded by the isolation layer 412 and the passivation layer 413, such that the thermal resistance portion 42 is located within the supporting member 41. The thermal resistance portion 42 may be made of a solid or liquid material which contracts (or expands) slowly; in this embodiment, the thermal conductivity of the thermal resistance portion 42 is less than a mean thermal conductivity or the minimum thermal conductivity of the supporting member 41. For example, the thermal conductivity of the thermal resistance portion may be equal to or less than 150 W/(m·K). In this embodiment, the recess 411a has a depth D4 and a width W4 in a ratio equal to or less than 5:1, but the present disclosure is not limited thereto.

In addition, the sensing units 43 and the heating unit 44 are disposed on the supporting surface 410, and an orthogonal projection of the heating unit 44 on the supporting surface 410 overlaps an orthogonal projection of the thermal resistance portion 42 on the supporting surface 410. The heating unit 44 is disposed at a position capable of heating the sensing units 43, but the distance therebetween is not particularly restricted.

The method of manufacturing the sensing device 4 includes the following steps.

The recess 411a is formed on the substrate 411 of the supporting member 41, and the recess 411a has the depth D4 and the width W4 in a ratio equal to or less than 5:1. The isolation layer 412 is stacked on the substrate 411 and the inner surface of the recess 411a. The recess 411a is filled with the thermal resistance portion 42, and the thermal resistance portion 42 and the substrate 411 are separated by the isolation layer 412. The passivation layer 413 is stacked on the isolation layer 412 and the thermal resistance portion 42. The sensing units 43 and the heating unit 44 are disposed on the supporting surface 410 of the passivation layer 413 of the supporting member 41. The orthogonal projection of the heating unit 44 on the supporting surface 410 overlaps the orthogonal projection of the thermal resistance portion 42 on the supporting surface 410. The heating unit 44 is disposed at a position capable of heating the sensing units 43, but the distance therebetween is not particularly restricted.

Please refer to FIG. 10 which is a cross-sectional side view of a sensing device according to further another embodiment of the disclosure. This embodiment provides a sensing device 5 which includes a supporting member 51, a thermal resistance portion 52, a plurality of sensing units 53 and a heating unit 54.

The supporting member 51 includes a substrate 511, an isolation layer 512 and a passivation layer 513. The substrate 511 has a plurality of recesses 511a. Each recess 511a has a depth D5 and a width W5 in a ratio ranging from 6:1 to 9:1. The isolation layer 512 is stacked on the substrate 511 and in contact with an inner surface of each recess 511a. The passivation layer 513 is stacked on the isolation layer 512. The part of the passivation layer 513 in the recess 511a form a plurality of sealed chambers, and these sealed chambers become a thermal resistance portion 52. That is, the thermal resistance portion 52 is located within the supporting member 51, and the thermal resistance portion 52 is consisted of a plurality of sealed chambers. The supporting member 51 has a supporting surface 510 on a side of the passivation layer 513 facing away from the isolation layer 512. The thermal conductivity of the thermal resistance portion 52 is approximately the same as that of a vacuum environment or an almost vacuum environment and is less than a mean thermal conductivity or the minimum thermal conductivity of the supporting member 51.

In addition, the sensing units 53 and the heating unit 54 are disposed on the supporting surface 510, an orthogonal projection of the heating unit 54 on the supporting surface 510 overlaps an orthogonal projection of the thermal resistance portion 52 on the supporting surface 510. The heating unit 54 is disposed at a position capable of heating the sensing units 53, but the distance therebetween is not particularly restricted.

The method of manufacturing the sensing device 5 includes the following steps.

The recesses 511a are formed on the substrate 511 of the supporting member 51. Each recess 511a has the depth D5 and the width W5 in a ratio ranging from 6:1 to 9:1.

The isolation layer 512 is stacked on the substrate 511 and in contact with the inner surface of each recess 511a. The passivation layer 513 is stacked on the isolation layer 512. A part of the passivation layer 513 is in the recesses 511a, but each recess 511a is not fully filled with the passivation layer 513 so as to form the recesses 511a that each is a sealed chamber. Therefore, the recesses 511a become a thermal resistance portion 52. The isolation layer 512 is formed on the substrate 511 by a process of Atomic Layer Deposition (ALD), but the process for forming the isolation layer 512 is not restricted. The passivation layer 513 is formed on the isolation layer 512 by a process of Physical Vapor Deposition (PVD) or Chemical Vapor Deposition (CVD), but the process for forming the passivation layer 513 is not restricted. A deposition rate of the isolation layer 512 onto the substrate 511 is equal to or less than 10 Å/sec. A deposition rate of the passivation layer 513 onto the isolation layer 512 is equal to or greater than 30 Å/sec. By doing so, the isolation layer 512 is able to fully cover the inner surface of each recess 511a, the material of the passivation layer 513 would not enter the recesses 511a, such that the recesses 511a are maintained sealed. In some cases, there are approximately less 60% of the space in each recess 511a, excluding the isolation layer 512, being occupied by the passivation layer 513.

The sensing units 53 and the heating unit 54 are disposed on the supporting surface 510 of the passivation layer 513 of the supporting member 51. The orthogonal projection of the heating unit 54 on the supporting surface 510 overlaps the orthogonal projection of the thermal resistance portion 52 on the supporting surface 510. The heating unit 54 is disposed at a position capable of heating the sensing units 53, but the distance therebetween is not particularly restricted.

According to the sensing device and method for manufacturing the same as discussed in above, the orthogonal projection of the thermal resistance portion on the supporting surface overlapping the orthogonal projection of the heating unit on the supporting surface is beneficial to slow down the heat transfer between the heating unit and the supporting member. Therefore, it is possible to maintain the temperature of the sensing unit which is heated by the heating unit, and to reduce the energy consumption of the heating unit while maintaining the sensing effect of the sensing unit. That is, the temperature of the sensing unit can be raised in an efficient manner, such that the desired function of the sensing unit can be maintained with a less power consumption of the heating unit.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A sensing device, comprising:
a supporting member, having a supporting surface;
a thermal resistance portion, located within the supporting member, wherein a thermal conductivity of the thermal resistance portion is less than a thermal conductivity of the supporting member;
a sensing unit, disposed on the supporting surface; and
a heating unit, disposed on the supporting surface, wherein the heating unit is configured to heat the sensing unit, and an orthogonal projection of the heating unit on the supporting surface overlaps an orthogonal projection of the thermal resistance portion on the supporting surface.

2. The sensing device according to claim 1, wherein the thermal resistance portion comprises at least one sealed chamber, at least one open chamber or a thermal resistance material, and the thermal conductivity of the thermal resistance portion is equal to or less than 150 W/(m·K).

3. The sensing device according to claim 1, wherein the supporting member comprises a substrate, an isolation layer and a passivation layer, the substrate has at least one recess, the isolation layer is stacked on the substrate, the passivation layer is stacked on the isolation layer, the supporting surface is on a side of the passivation layer facing away from the isolation layer, the thermal resistance portion is located in the at least one recess and surrounded by the substrate and the isolation layer, the isolation layer and the passivation layer, or a part of the passivation layer in the at least one recess.

4. The sensing device according to claim 3, wherein the at least one recess has a depth and a width in a ratio equal to or less than 2:1.

5. The sensing device according to claim 4, wherein the supporting member has a through hole connected to the thermal resistance portion.

6. The sensing device according to claim 5, wherein the supporting member further comprises a sealer disposed in the through hole.

7. The sensing device according to claim 3, wherein the at least one recess has a depth and a width in a ratio equal to or greater than 10:1, and the thermal resistance portion is located in the at least one recess and surrounded by the substrate and the isolation layer.

8. The sensing device according to claim 3, wherein the at least one recess has a depth and a width in a ratio ranging from 6:1 to 9:1, and the thermal resistance portion is located in the at least one recess and surrounded by the part of the passivation layer in the at least one recess.

9. A method for manufacturing a sensing device, comprising:
forming a thermal resistance portion within a supporting member, wherein a thermal conductivity of the thermal resistance portion is less than a thermal conductivity of the supporting member;
disposing a sensing unit on a supporting surface of the supporting member; and
disposing a heating unit on the supporting surface of the supporting member, wherein the heating unit is configured to heat the sensing unit, and an orthogonal projection of the heating unit on the supporting surface overlaps an orthogonal projection of the thermal resistance portion on the supporting surface.

10. The method according to claim 9, wherein the thermal resistance portion comprises at least one sealed chamber, at least one open chamber or a thermal resistance material, and the thermal conductivity of the thermal resistance portion is equal to or less than 150 W/(m·K).

11. The method according to claim 9, wherein forming the thermal resistance portion within the supporting member further comprises:
forming at least one recess in a substrate;
stacking an isolation layer on the substrate; and
stacking a passivation layer on the isolation layer, wherein the supporting surface is on a side of the passivation layer facing away from the isolation layer, the thermal resistance portion is located in the at least one recess and surrounded by the substrate and the isolation layer, the isolation layer and the passivation layer, or a part of the passivation layer in the at least one recess.

12. The method according to claim 11, wherein the at least one recess has a depth and a width in a ratio equal to or less than 2:1.

13. The method according to claim 12, wherein forming the thermal resistance portion within the supporting member further comprises:
filling a volatile substance into the at least one recess;
forming a through hole in the supporting member to be connected to the at least one recess; and
volatilizing the volatile substance away from the substrate through the through hole so as to form the thermal resistance portion within the supporting member.

14. The method according to claim 13, further comprising, after volatilizing the volatile substance away from the substrate through the through hole:
disposing a sealer in the through hole.

15. The method according to claim 11, wherein the at least one recess has a depth and a width in a ratio equal to or greater than 10:1.

16. The method according to claim 15, wherein the isolation layer is stacked on the substrate by a process of Physical Vapor Deposition (PVD) or Chemical Vapor Deposition (CVD).

17. The method according to claim 15, wherein a deposition rate of the isolation layer onto the substrate is equal to or greater than 30 Å/sec.

18. The method according to claim 11, wherein the at least one recess has a depth and a width in a ratio ranging from 6:1 to 9:1, and the thermal resistance portion is located in the at least one recess and surrounded by the part of the passivation layer in the at least one recess.

19. The method according to claim 18, wherein the isolation layer is stacked on the substrate by a process of Atomic Layer Deposition (ALD), and the passivation layer is stacked on the isolation layer by a process of Physical Vapor Deposition (PVD) or Chemical Vapor Deposition (CVD).

20. The method according to claim 18, wherein a deposition rate of the isolation layer onto the substrate is equal to or less than 10 Å/sec, and a deposition rate of the passivation layer onto the isolation layer is equal to or greater than 30 Å/sec.
